(19) United States
(12) Patent Application Publication
(10) Pub. No.: US 2024/0138628 A1
(43) Pub. Date: May 2, 2024

(54) SPATULA

(71) Applicant: Joseph John Calhoun, Luck, WI (US)

(72) Inventor: Joseph John Calhoun, Luck, WI (US)

(21) Appl. No.: 18/384,296

(22) Filed: Oct. 26, 2023

Related U.S. Application Data
(60) Provisional application No. 63/419,967, filed on Oct. 27, 2022.

(51) Int. Cl. A47J 43/28

(52) U.S. Cl. CPC A47J 43/288

(57) ABSTRACT

A spatula includes a handle and a blade including: a first end coupled to the handle, a second end opposite the first end, a convex lower surface facing a downward direction and configured to engage a cooking surface, and a concave upper surface opposite the lower surface and facing an upward direction opposite the downward direction.

### CROSS-REFERENCE TO RELATED PATENT APPLICATION

This application claims the benefit of and priority to U.S. Provisional Application No. 63/419,967, filed Oct. 27, 2022, the entire disclosure of which is incorporated by reference herein.

### BACKGROUND

The present disclosure relates generally to a cooking tool or utensil, and more specifically, to a spatula having improved flexibility, strength, and usability characteristics.

### SUMMARY

One embodiment a spatula. The spatula includes a handle and a blade. The blade includes a first end coupled to the handle and a second end opposite the handle. The blade also includes a convex lower surface facing a downward direction and configured to engage a cooking surface. The blade also includes a concave upper surface opposite the convex lower surface and facing an upward direction opposite the downward direction.

A first force required to deflect the second end of the blade in the upward direction may be less than a second force required to deflect the second end of the blade in the downward direction. A radius curvature of the concave upper surface of the blade increases between the first end of the blade and the second end of the blade. A radius of curvature of the blade at the first end may be approximately 2.25 inches. The blade may be made of steel and the handle may be made of a polymer. A thickness of the blade may be between about 0.010 inches and 0.012 inches. The second end of the blade can include a distal edge. The distal edge can include rounded corners on lateral sides of the blade and being rounded over between the convex lower surface and the concave upper surface.

The spatula may further include at least one mechanical fastener fastening the blade to the handle. The at least one mechanical fastener may include a rivet or a threaded fastener. The handle may be overmolded onto the blade. The handle may extend along a first longitudinal axis. The blade can extend along a second longitudinal axis angularly offset from the first longitudinal axis.

Another embodiment relates to a spatula. The spatula includes a polymer handle and a metal blade. The metal blade extends along a longitudinal axis and has a radius of curvature in a direction radially outward from the longitudinal axis such that an upper surface of the metal blade is concave. The metal blade includes a first end coupled to the polymer handle, a second end opposite the first end, a lower surface facing a downward direction and configured to engage a cooking surface, and the upper surface opposite the lower surface and facing an upward direction opposite the downward direction. A first force required to deflect the second end of the metal blade in the upward direction may be less than a second force required to deflect the second end of the metal blade in the downward direction.

The radius of curvature of the metal blade at the first end can be approximately 2.25 inches. The second force can be at least ten times greater than the first force. The metal blade can have a thickness in a range of 0.008 inches to 0.020 inches. The thickness of the metal blade can be between 0.010 inches and 0.012 inches.

Another embodiment relates to a spatula. The spatula includes a handle and a blade. The blade includes a first end and a second end. The first end is coupled to the handle and has a first value of a radius of concavity. The second end is opposite the first end and has a second value of the radius of concavity different than the first value. The first value of the radius of concavity and the second value of the radius of concavity of the blade result in limiting the second end of the blade from bending in a downward direction when a first downward force is applied.

The radius of concavity of the blade can increase from the first end of the blade to the second end of the blade. The second end of the blade can be prevented from bending in the downward direction until a second downward force is applied. The second downward force may be larger than the first downward force.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIGS. 1-2 are perspective views of a spatula according to one embodiment.

FIG. 3 is a perspective view of a spatula according to another embodiment.

FIG. 4 is a side view of the spatula of FIG. 3 according to one embodiment.

FIG. 5 is a top view of the spatula of FIG. 3 according to one embodiment.

FIG. 6 is a side view of the spatula of FIG. 3 according to one embodiment.

FIG. 7 is a blade end view of the spatula of FIG. 3 taken along axis 34 of FIG. 6 according to one embodiment.

FIG. 8 is a blade end view of the spatula of FIG. 3 taken along axis 32 of FIG. 6 according to one embodiment.

FIG. 9 is a handle end view of the spatula of FIG. 3 taken along axis 32 of FIG. 6 according to one embodiment.

FIG. 10 is a handle end view of the spatula of FIG. 3 taken along axis 34 of FIG. 6 according to one embodiment.

FIG. 11 is a perspective view of a spatula with a deflected blade end according to one embodiment.

FIG. 12 is a perspective view of a spatula according to another embodiment.

FIG. 13 is a side view of the spatula of FIG. 12 according to one embodiment.

FIG. 14 is a top view of the spatula of FIG. 12 according to one embodiment.

FIG. 15 is a side view of the spatula of FIG. 12 according to one embodiment.

FIG. 16 is a blade end view of the spatula of FIG. 12 taken along axis 34 of FIG. 15 according to one embodiment.

FIG. 17 is a blade end view of the spatula of FIG. 12 taken along axis 32 of FIG. 15 according to one embodiment.

FIG. 18 is a handle end view of the spatula of FIG. 12 taken along axis 32 of FIG. 15 according to one embodiment.

FIG. 19 is a handle end view of the spatula of FIG. 12 taken along axis 34 of FIG. 15 according to one embodiment.

FIG. 20 is a perspective view of a blade of the spatula of FIG. 1, according to one embodiment.

FIG. 21 is a perspective view of a blade of the spatula of FIG. 1, according to another embodiment.

FIG. 22 is a perspective view of a spatula according to another embodiment.

FIG. 23 is a side view of the spatula of FIG. 22 according to one embodiment.

FIG. 24 is a top view of the spatula of FIG. 22 according to one embodiment.

FIG. 25 is a handle end view of the spatula of FIG. 22 taken along axis 32 of FIG. 23 according to one embodiment.

FIG. 26 is a perspective view of the blade of the spatula of FIG. 22 according to one embodiment.

FIG. 27 is a side view of the blade of the spatula of FIG. 22 according to one embodiment.

FIG. 28 is a top view of the blade of the spatula of FIG. 22 according to one embodiment.

FIG. 29 is a handle end view of the spatula of FIG. 22 taken along axis 34 of FIG. 23 according to one embodiment.

FIGS. 30-39 are top views of different spatula blades, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, various embodiments disclosed herein are directed to a cooking tool, and more specifically, a spatula. The spatula is usable to lift food off of various surfaces and enable moving, flipping, etc. of the food. For example, a user may be preparing eggs in a non-stick pan, and may use the spatula to mix, flip, etc. the eggs during preparation. As disclosed in greater detail below, various features of the spatula discussed herein may facilitate using the spatula with non-stick pans and reducing any scratching, marring, etc. that may otherwise result from using a spatula with such pans.

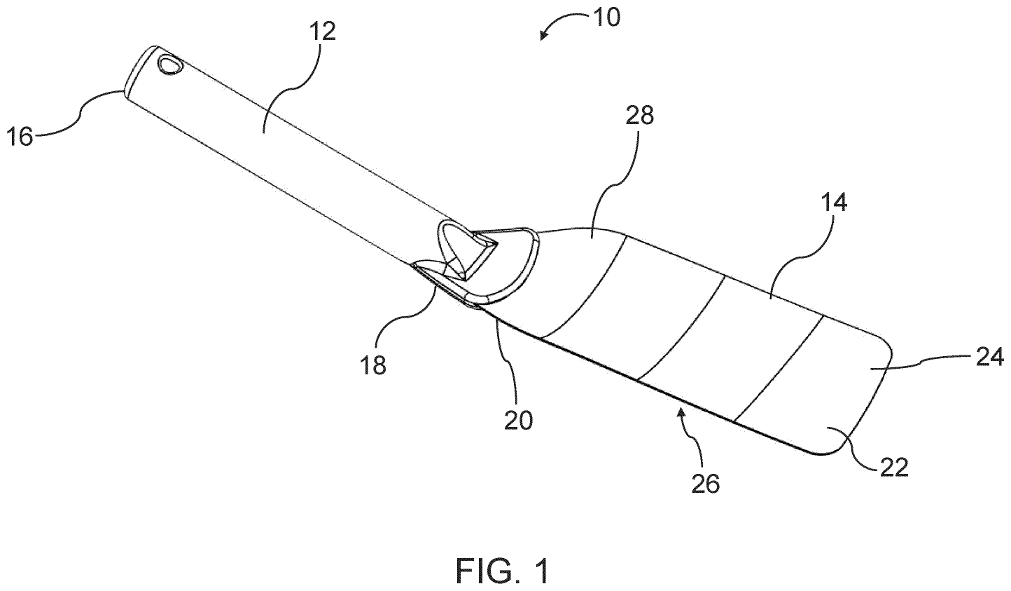

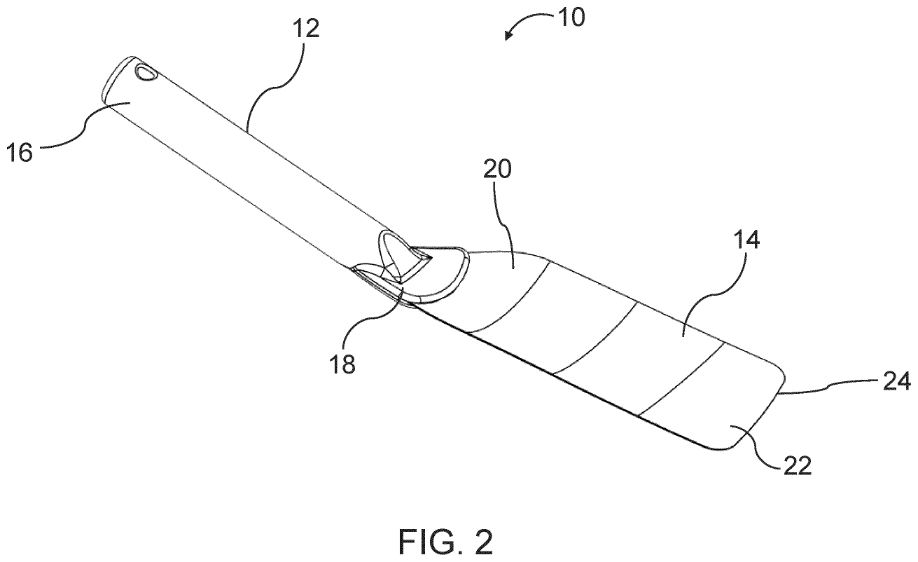

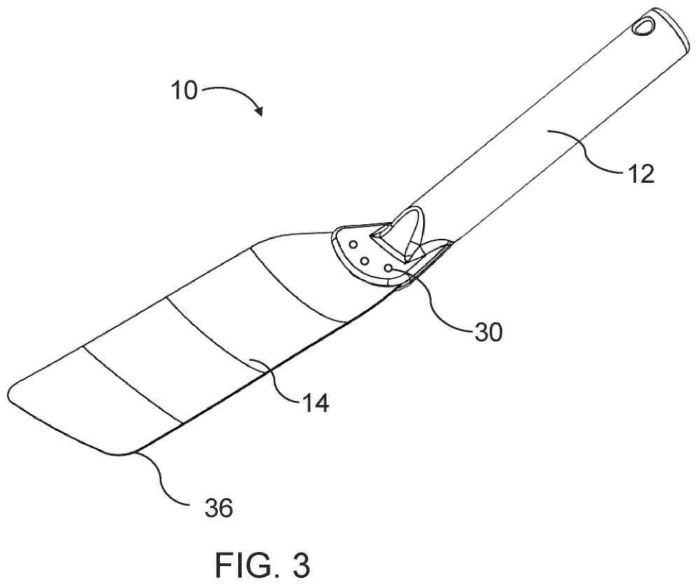

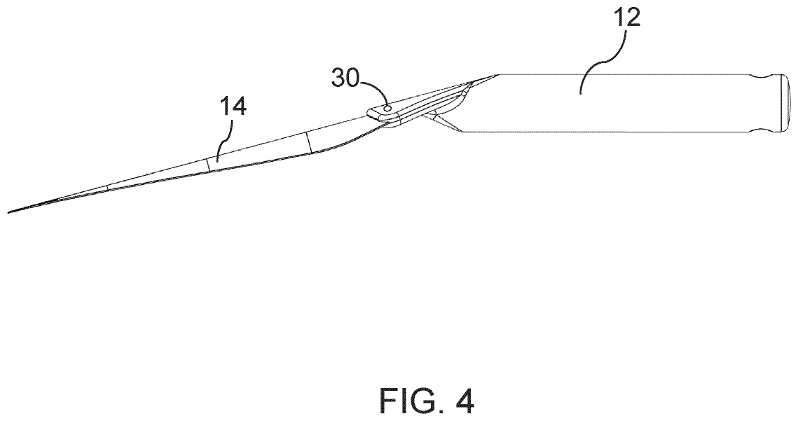

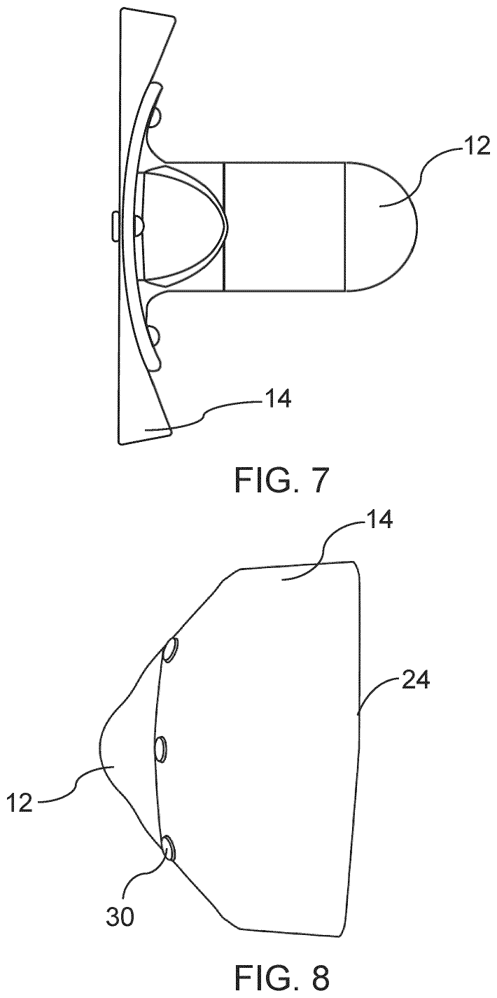

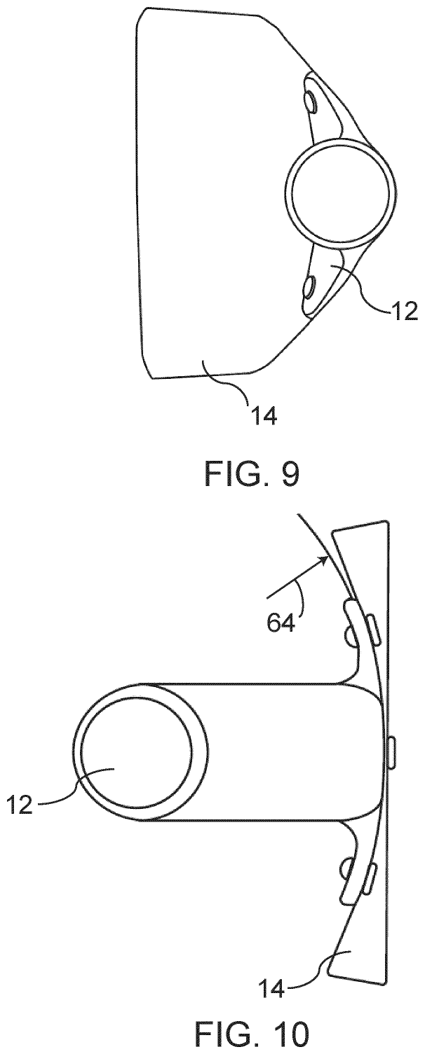

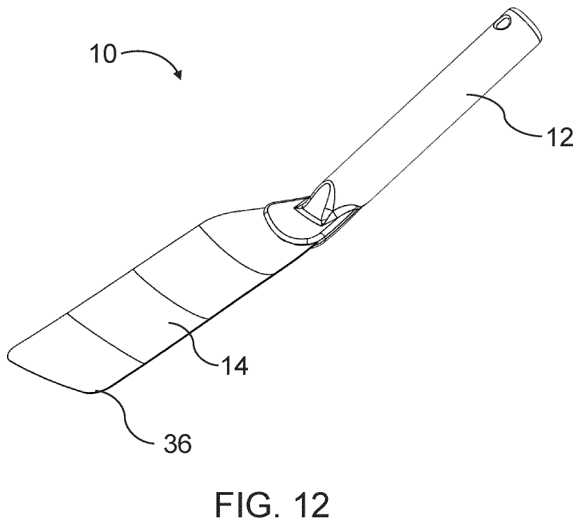

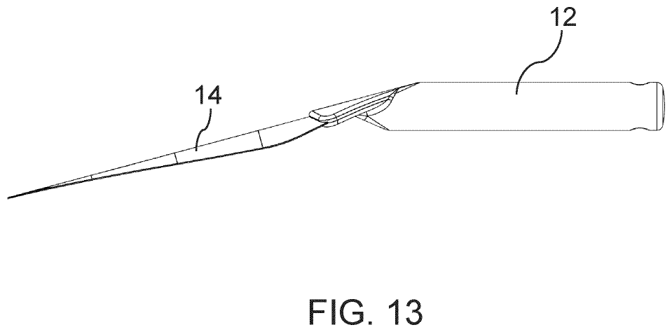

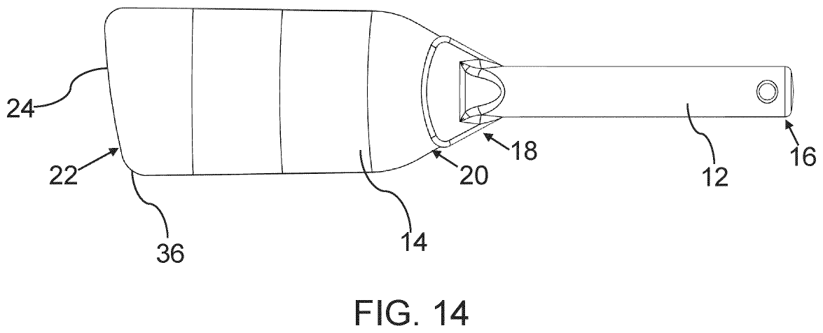

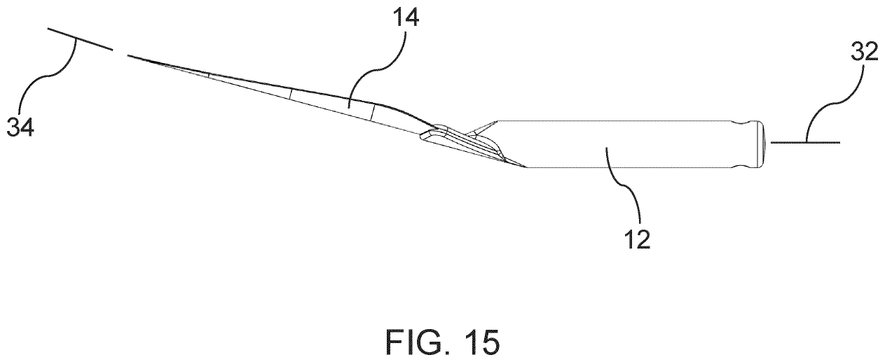

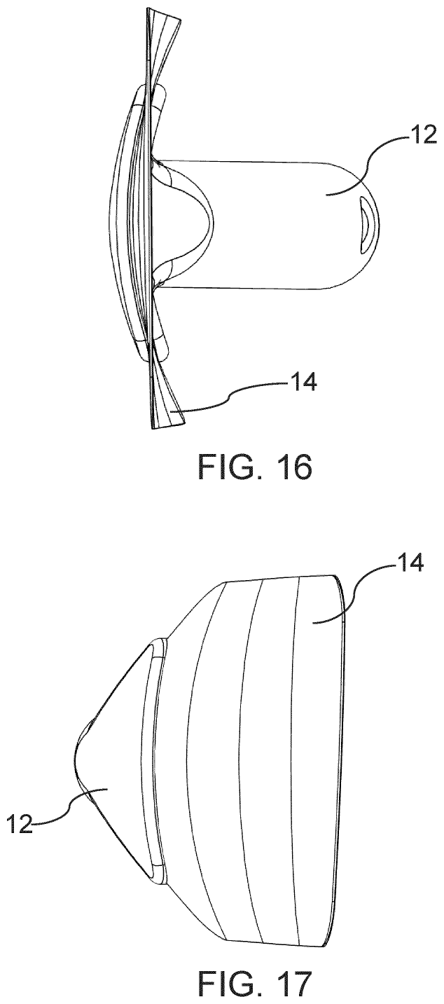

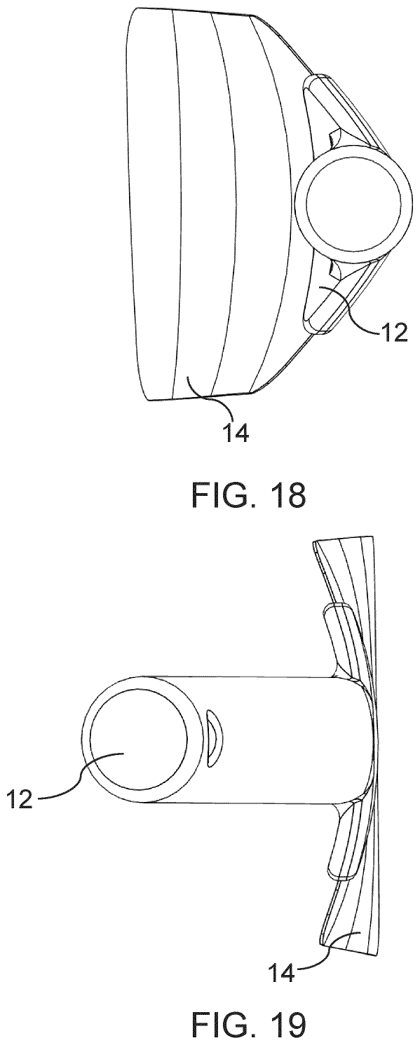

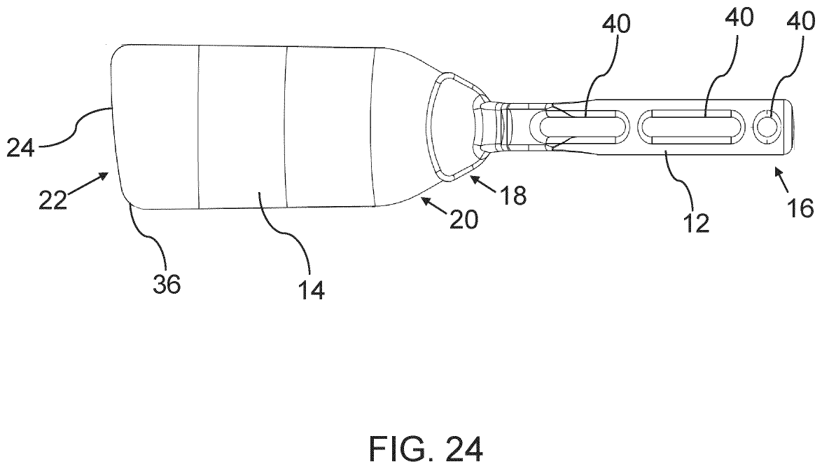

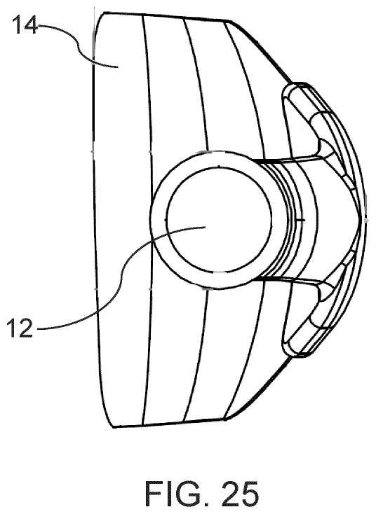

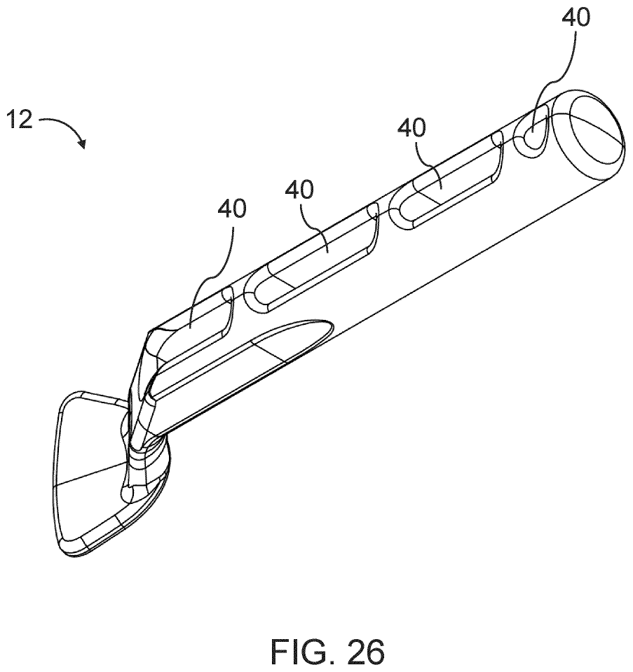

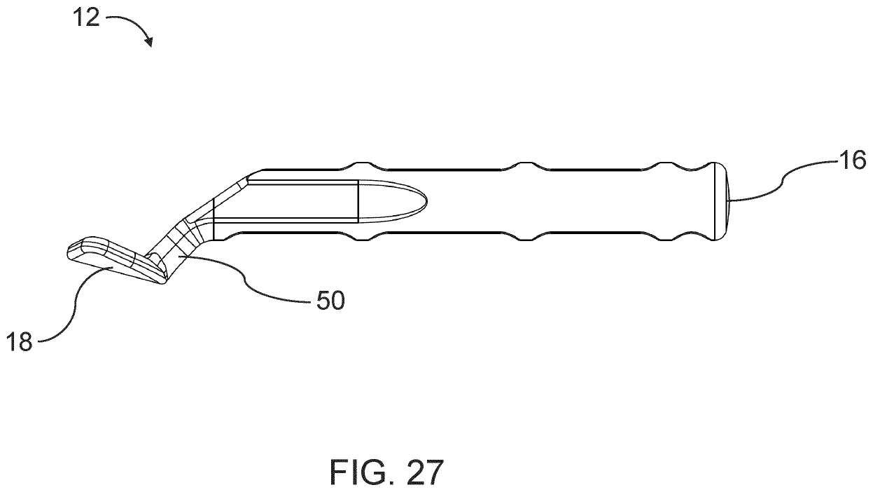

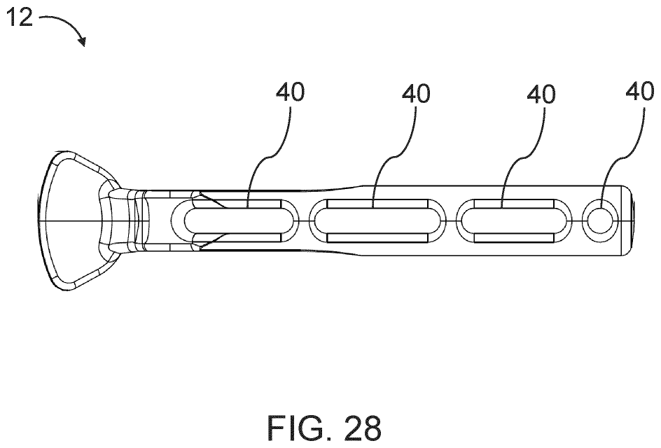

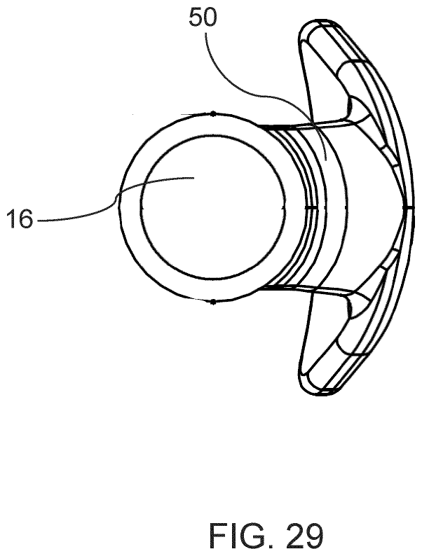

Referring now to FIGS. 1-30, a spatula (a cooking utensil, tool, or apparatus) 10 is shown according to one embodiment. The spatula 10 is configured to facilitate the movement and handling of food during preparation (e.g., placing food into/onto a cooking device, removing food from a cooking device, moving food on/within a cooking device, etc.). The spatula 10 includes a handle 12 (e.g., a gripping portion, a graspable portion. etc.) and a blade 14 (e.g., a flipping portion, a food support, etc.). The blade 14 is coupled to the handle 12. In one embodiment, the handle 12 includes a first end 16 and a second end 18. The blade 14 includes a first end 20 coupled to the second end 18 of the handle 12, and a second end 22 defining an edge 24. In FIGS. 1-2, 12-19, and 22-25 the spatula 10 is shown to have the handle 12 coupled to the blade 14 by, for example, overmolding a material onto the blade 14, while in FIGS. 3-11, the spatula 10 is shown as including a plurality of fasteners 30 to couple the handle 12 to the blade 14. It should be understood that the spatula may utilize either or other ways of coupling the handle 12 to the blade 14.

In one embodiment, the blade 14 includes a convex lower surface 26 (e.g., a first or lower surface) facing a downward direction. The convex lower surface 26 is configured to engage a cooking surface of a cooking device such as the surface of a pan, a pot, a grilling surface, a frying surface, etc. The blade 14 further includes a concave upper surface 28 (e.g., a second or upper surface). The concave upper surface 28 of the blade 14 is opposite the convex lower surface 26 of the blade 14. The concave upper surface 28 of the blade 14 faces an upward direction opposite the downward direction. The concave upper surface 28 is configured to hold or move food (e.g., during stirring, flipping, mixing, etc.). The concave upper surface 28 generally curves about a longitudinal axis (or axes) that runs parallel to the length of the blade 14.

In one embodiment, the concave upper surface 28 is concave between opposite lateral sides of the blade 14, and has a radius of curvature defining the degree of concavity. In one embodiment, the radius of curvature of the concave upper surface 28 increases from the first end 20 of the blade 14 to the second end 22 of the blade 14 (e.g., such that the blade 14 becomes “flatter” from the first end 20 to the second end 22). For example, the radius of curvature of the blade 14 may be about 2.25 inches at the first end 20 of the blade 14, and the radius of curvature may generally increase from the first end 20 to the second end 22 of the blade 14. In some embodiments, the radius of curvature may be substantially 10 inches at the second end 22 of the blade 14. In some embodiments, the edge 24 follows the concave shape of concave upper surface 28 (e.g., at the distal-most end of blade 14). In other embodiments, blade 14 becomes substantially flat at the distal-most end of blade 14 (e.g., having little or no concavity relative to concave upper surface 28).

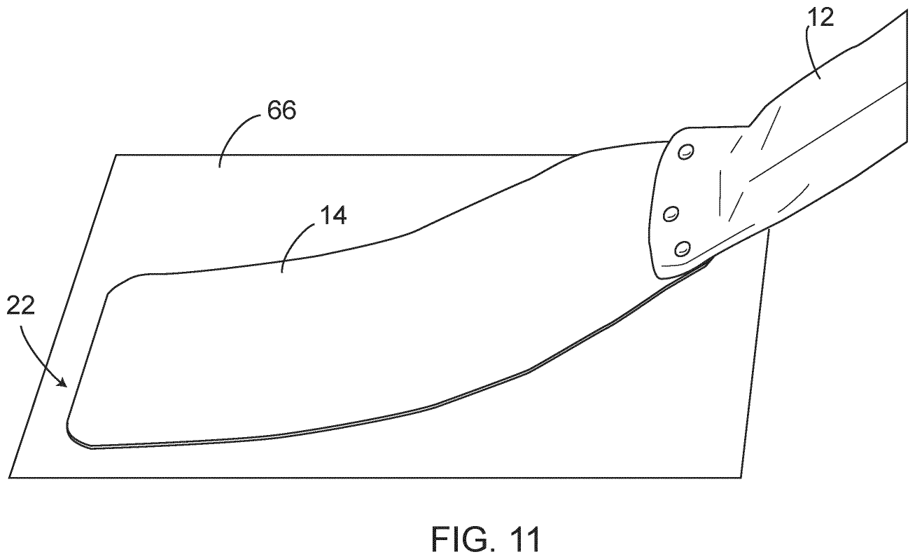

The blade 14 is configured to flex upward and downward during use by a user (e.g., during a cooking operation) depending on an amount of force applied by a user. The force required to deflect or flex the second end 22 of the blade 14 in the upward direction (e.g., as a result of an upward force applied at or near the second end 22 of the blade 14) as shown, for example, in FIG. 11, may be less than (e.g., several times less than) the force required to deflect the second end 22 of the blade 14 in the downward direction (e.g., as a result of a downward force being applied at or near the second end of the blade). For example, a user may be using the spatula 10 with a pan and engage a working surface of the pan with the second end 22 of the blade 14. The second end 22 of the blade 14 may deflect or bend upward relative to a remainder of the blade 14 in response to the upward force applied to the second end 22 of the blade 14 by the pan. In some embodiments, and as shown in FIG. 11, the blade 14 is configured such that the portion of blade 14 that engages a working surface 66 and is deflected relative to the remainder of the blade 14 becomes substantially flat or matching the working surface 66, thereby facilitating use of that portion of the blade along a similarly flat working surface of a pan, grilling surface, etc. Similarly, a user may lift food positioned at or near the second end 22 of the blade 14, and the second end 22 of the blade 14 may resist bending in a downward direction relative to a remainder of the blade 14 until a relatively larger force (e.g., downward force) is applied (e.g., as a result of trying to lift a heavy portion of food, etc.). As shown in FIG. 10, the blade 14 may interface or abut the handle 12 with a radius of curvature 64 of substantially 2.25 inches.

In one embodiment, the second end 22 of the blade 14 may be configured to deflect upward relative to a remainder of the blade 14 in response to a minimum upward force of about 0.10 ounce-forces, and the second end 22 of the blade 14 may be configured to deflect downward in response to a minimum downward force of about 52 ounce-forces (i.e., 3 pounds, 4 ounces). As such, the downward force required to bend or deflect the blade downward may be at least about twice the upward force required to deflect the blade upward, or may be at least 10 times the upward force, or may be at least twenty times or more the upward force. As a result, the spatula 10 provides a blade 14 configured to support food without flexing downward under normal weighted conditions, while being flexible enough in an upward direction to avoid scratching working surfaces (e.g., a surface of a non-stick pan, such as Teflon, etc.).

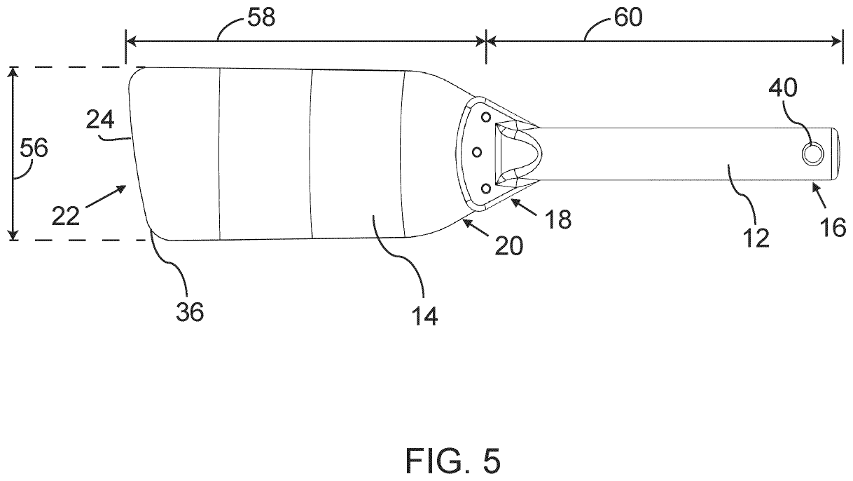

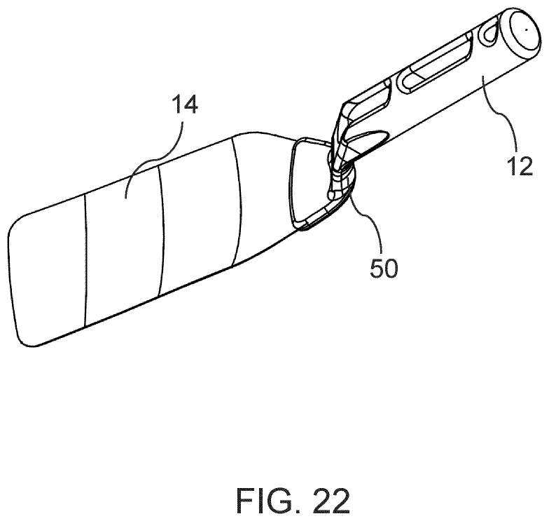

Referring further to the FIGURES, in one embodiment, the handle 12 is an elongated member extending from the first end 16 to the second end 18. The handle 12 may include gripping features or a texture configured to facilitate gripping of the handle 12 by a user, such as handle 12 shown in FIGS. 22-29. The handle 12 may have any suitable cross-sectional shape, including circular, oval, square rectangular, irregular shapes, etc. In one embodiment, the handle 12 is generally cylindrical in shape along at least a portion of a length of the handle 12, and has a dimeter of about 0.75 inches. In other embodiments larger or smaller diameters may be utilized. The handle 12 may in some embodiments be about 6 inches long. In other embodiments the handle 12 may be longer or shorter. In some embodiments, the handle 12 may include a through hole created by a rounded interface 40 at the first handle end 16, such as those shown in FIG. 5. The through hole may allow the spatula 10 to be hung, such as on a hook, to store the spatula 10. The handle 12 may also include additional oblong cavities created by rounded interfaces 40, such as those shown in the embodiment of FIGS. 22-29. The embodiment of the spatula 10 shown in FIG. 5 may have a blade length 58 of substantially 5.5 inches. As shown in FIG. 5, the remainder of length 60 of the spatula 10 is defined by handle 12. The length 60 as shown in FIG. 5 may be substantially 6 inches, resulting in the spatula 10 having an overall length of 11.5 inches. The blade 14 may have a width 56 of 2.5 inches in the embodiment shown in FIG. 5.

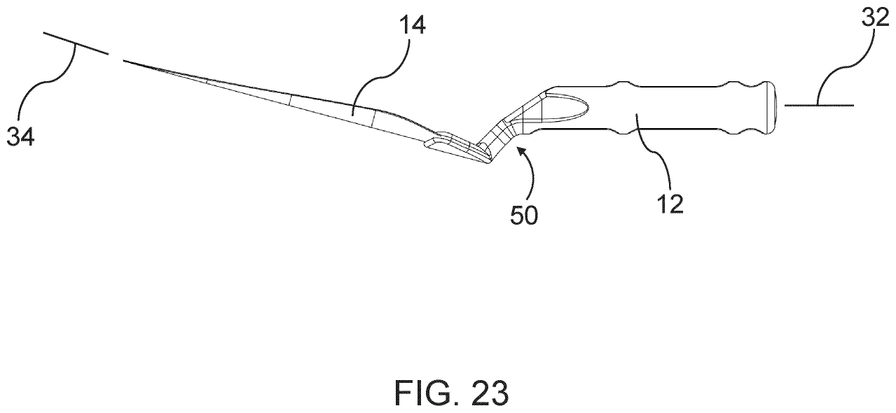

In some embodiments, such as the embodiment shown in FIGS. 22-29, the handle 12 of the spatula 10 may include an offset portion 50. The offset portion 50 of the handle 12 can create an increased distance between the hand of a user holding the handle 12 and a hot cooking surface, such as a pan, that the blade 14 is engaging with. In some embodiments, the offset portion 50 of the handle 12 is at a 15 degree angle relative to the second handle end 18 of the handle 12, such as shown in FIG. 23. In some embodiments, the angle of the offset portion 50 of the handle 12 may be smaller or larger than 15 degrees relative to the second handle end 18 of the handle 12. The handle 12 including the offset portion 50 may be secured to the blade 14 via fasteners 30 or another method, such as an adhesive.

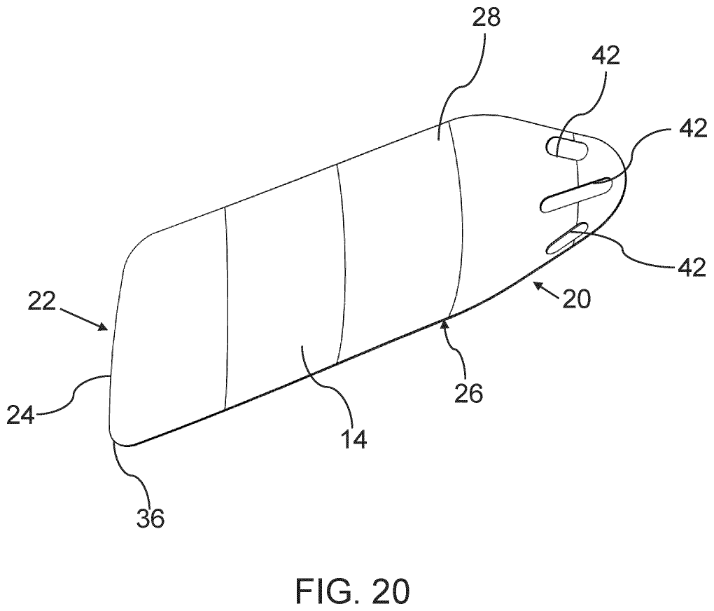

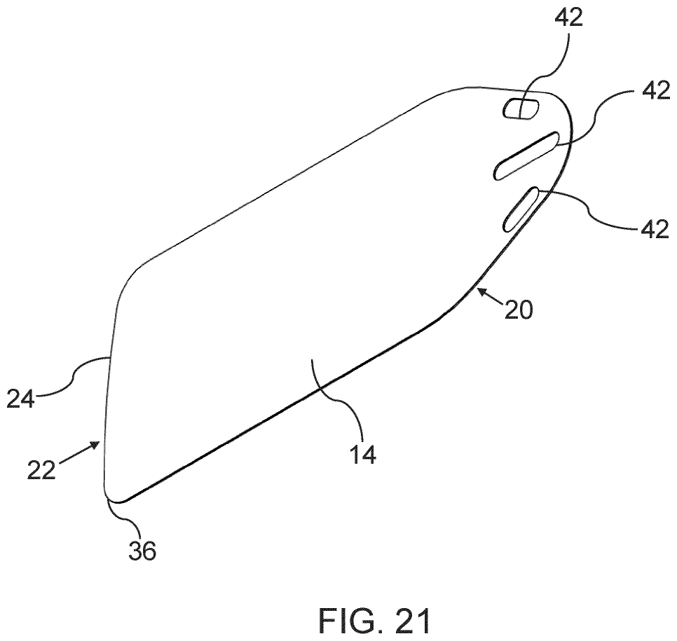

In one embodiment, the second end 18 of the handle 12 includes an interface portion configured to receive a portion of the blade 14 (e.g., the first end of the blade). The interface portion may have a curvature that matches a curvature of the first end 20 of the blade 14. In some embodiments, one or more mechanical fasteners 30 (e.g., screws, rivets, etc.) are used to secure the blade 14 to the handle 12 at the interface portion. In other embodiments, other means of fastening the blade 14 to the handle 12 may be used. For example, in one embodiment, the handle 12 is overmolded onto the blade 14 (e.g., as part of an injection molding process). In some embodiments, the blade 14 may include rounded slots formed by interfaces 42 at the first blade end 20, as shown in FIGS. 20 and 21, to help secure the blade 14 to the handle 12. In alternative embodiments, an adhesive may be used to secure the blade 14 to the handle 12.

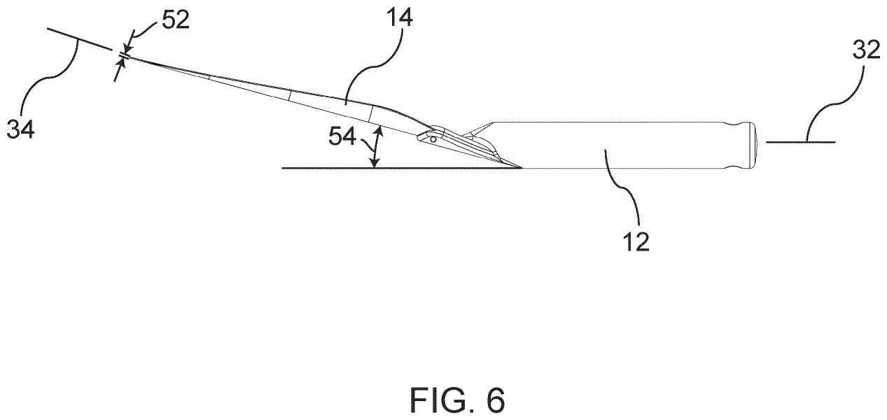

In one embodiment, the blade 14 is made of steel (e.g., stainless steel, type 316 stainless steel, etc.). The blade 14 may have a thickness 52 (shown in FIG. 6) in the range of about 0.010 inches to 0.012 inches. In other embodiments, the blade 14 may be thicker or thinner to provide desired levels of strength, stiffness, flexibility, etc. In one embodiment, the blade has a length of about 5.5 inches and a width of about 2.5 inches. In various alternative embodiments, other lengths and widths may be used for the blade.

In some embodiments, the handle 12 and the blade 14 are angularly offset relative to each other. The handle 12 defines a first axis 32 (e.g., a first longitudinal axis). The blade 14 defines a second axis 34 (e.g., a second longitudinal axis). The first axis 32 may be angularly offset from the second axis 34. For example, the first axis 32 may be angularly offset from the second axis 34 by an angle 54 of about 15 degrees. In other embodiments, the angular offset may be greater or less. In some embodiments, the angular offset is at the interface of the handle 12 and the blade 14.

Referring further to FIG. 8, in some embodiments, the edge 24 of the blade 12 is configured to reduce or prevent scratching of a working surface. The edge 24 extends between the lateral sides of the blade 12 and between the top concave surface 28 of the blade 14 and the bottom convex surface 26 of the blade 14. The edge 24 includes rounded corners 36 adjacent the lateral sides of the blade 14. The edge 24 may be rounded between the top concave surface 28 and the bottom convex surface 26. The combination of the rounded corners 36 and the rounded edge 24 between the top and bottom surfaces 28, 26 assist in reducing and/or preventing scratching of working surfaces such as non-stick surfaces of pans, pots, grills, etc. In some embodiments, the rounded corners 36 of the blade 14 may vary in radius, such as shown in FIGS. 8, 14, and 24. For example, a first corner at the second blade end 22 of the blade 14 may have a radius of 0.3 inches, while a second corner at the second blade end 22 of the blade 14 may have a radius of 0.4 inches. In various embodiments, the rounded corners 36 at the first blade end 20 of the blade 14 may have a larger radius than the rounded corners 36 at the second blade end 22 of the blade 14.

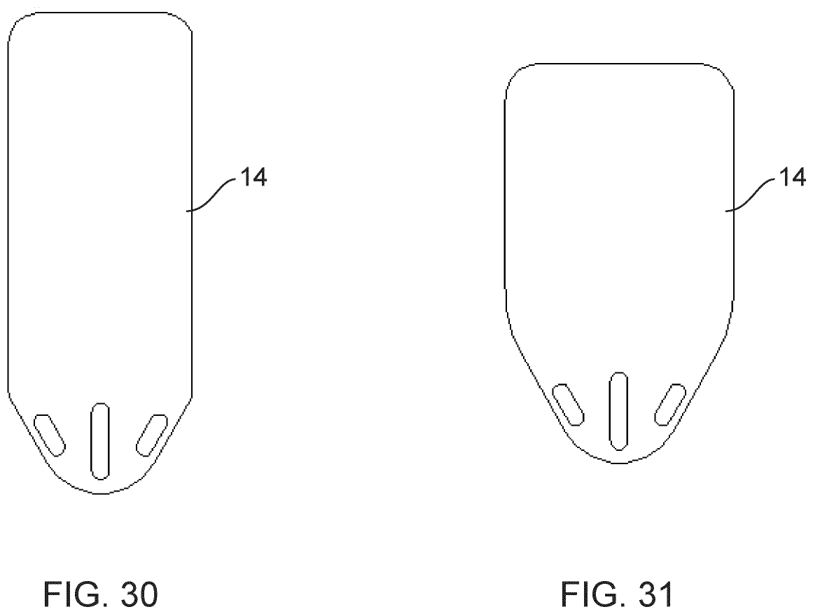

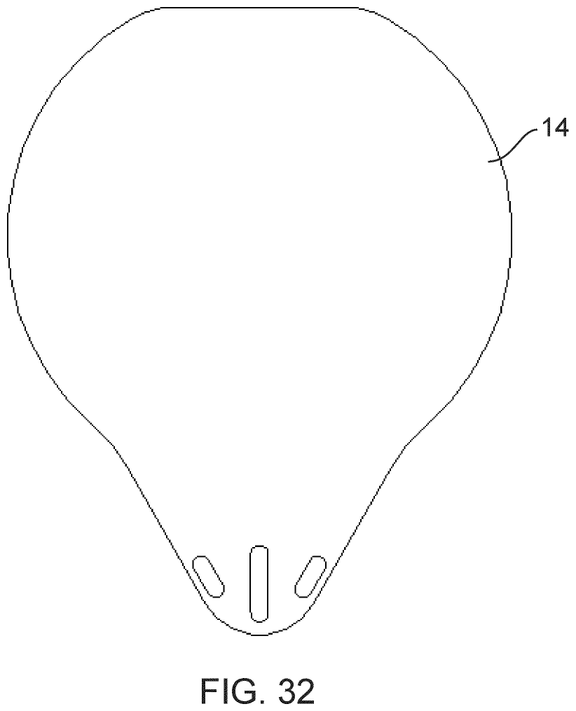

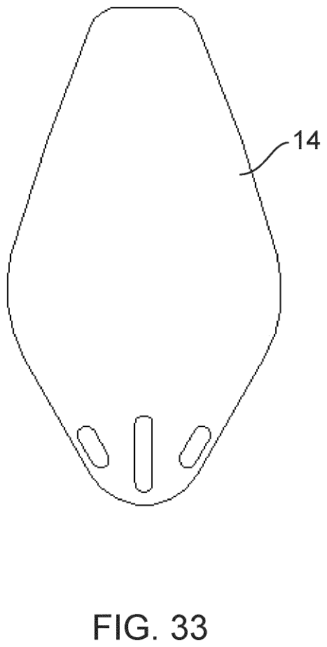

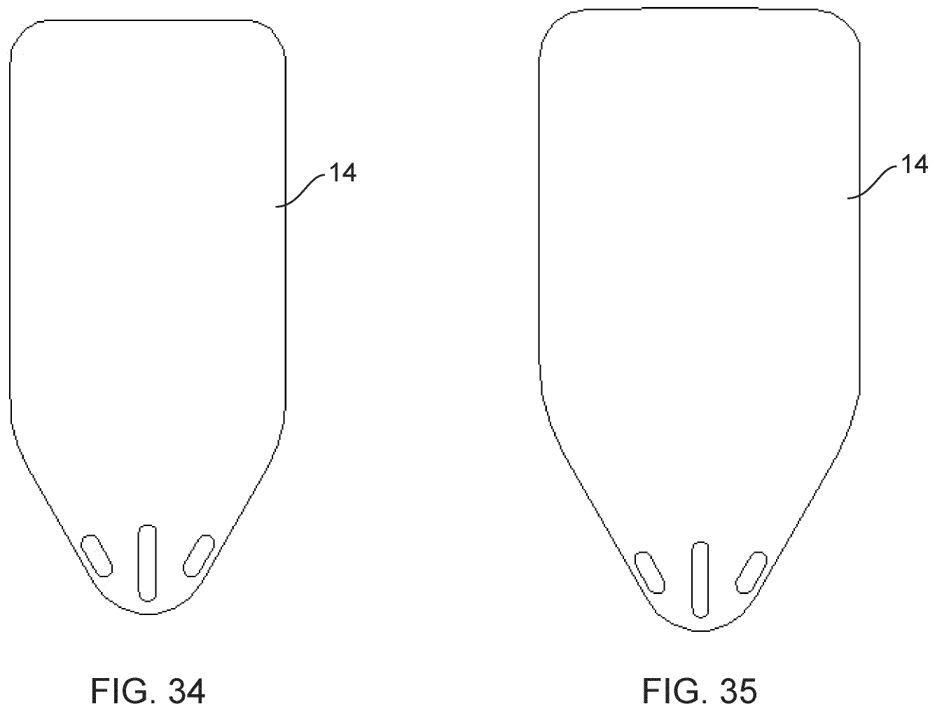

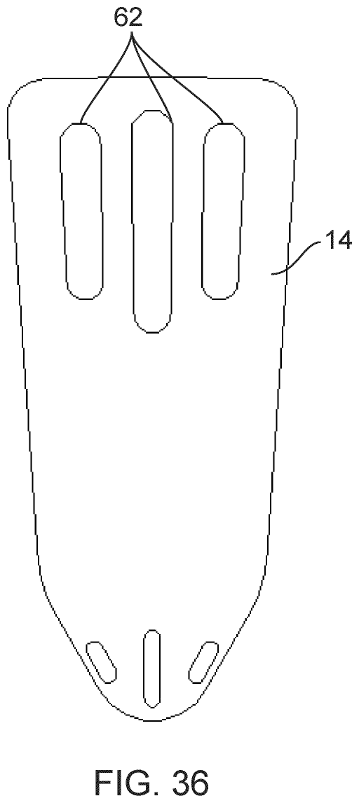

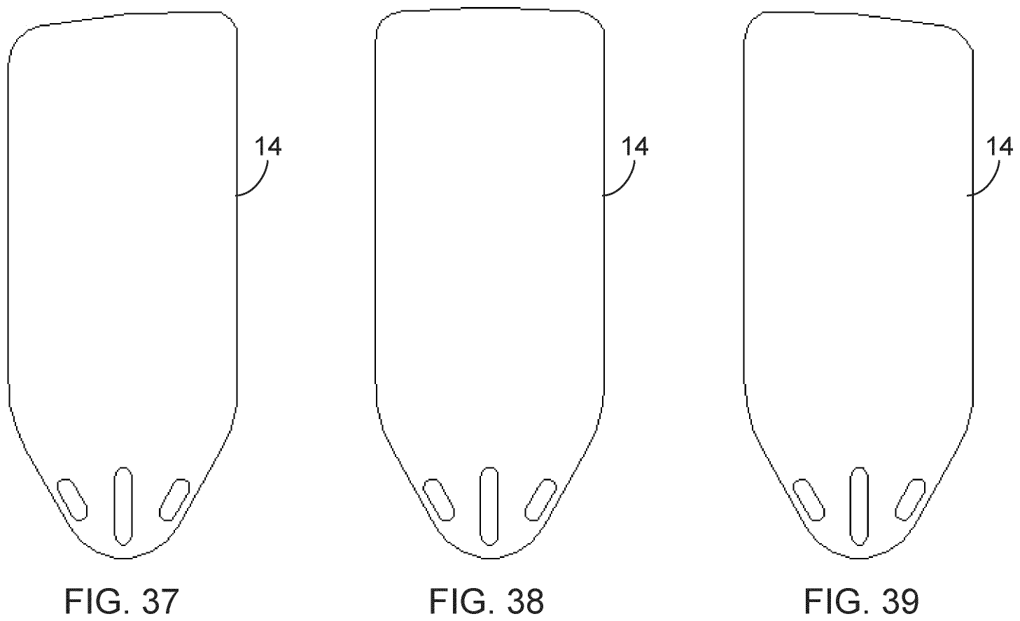

Referring further to FIGS. 30-39, a variety of different blades 14 are shown. In various embodiments, any of the blades 14 shown in FIGS. 30-39 may be used on spatula 10. In some embodiments, blade 14 may include slots 62 at the second blade end 22 of the blade 14. As shown in FIGS. 30 and 31, the blade 14 may have an overall rectangular shape having different dimensions to provide a longer and thinner blade 14 or a shorter and wider blade 14. As shown in FIG. 32, the blade 14 may include curved edges that extend from angled edges and terminate at a generally straight edge of the blade 14. As shown in FIG. 33, the blade 14 may have increasing width along a first portion and decreasing width along a second portion. As shown in FIGS. 34-35, the blade 14 may include different widths having substantially the same overall length. As shown in FIG. 36, the blade 14 may include slots in an end to facilitate allowing grease or other kitchen debris to pass through the blade 14 during use. As shown in FIGS. 37-39, an end of the blade 14 may be tapered in either direction. The thickness of any of the blades 14 as described herein may vary from 0.008 inches to 0.020 inches to provide different stiffnesses.

Providing a spatula such as spatula 10 having the features disclosed herein may provide various advantages relative to more conventional designs. For example, the spatula enables usage of a metal blade with non-stick working surfaces while reducing or preventing scratching of the working surface. To enable this and also to facilitate usage of the spatula, the spatula is configured to bend or flex more easily upward than downward. As such, while the spatula may flex or bend relatively easily upward (e.g., to prevent scratching), the spatula is able to support normal food loads during food preparation without flexing or bending in a downward direction.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the spatula as shown in the various exemplary embodiments is illustrative only. Additionally, any element disclosed in one embodiment may be incorporated or utilized with any other embodiment disclosed herein.

What is claimed is:

1. A spatula comprising:
a handle; and
a blade comprising:
a first end coupled to the handle;
a second end opposite the first end;
a convex lower surface facing a downward direction and configured to engage a cooking surface; and
a concave upper surface opposite the convex lower surface and facing an upward direction opposite the downward direction.

2. The spatula of claim 1, wherein a first force required to deflect the second end of the blade in the upward direction is less than a second force required to deflect the second end of the blade in the downward direction.

3. The spatula of claim 1, wherein a radius curvature of the concave upper surface of the blade increases between the first end of the blade and the second end of the blade.

4. The spatula of claim 1, wherein a radius of curvature of the blade at the first end is approximately 2.25 inches.

5. The spatula of claim 1, wherein the blade is made of steel and the handle is made of a polymer.

6. The spatula of claim 1, wherein a thickness of the blade is between about 0.010 inches and 0.012 inches.

7. The spatula of claim 1, wherein the second end of the blade comprises a distal edge, the distal edge comprising rounded corners on lateral sides of the blade and being rounded over between the convex lower surface and the concave upper surface.

8. The spatula of claim 1, further comprising at least one mechanical fastener fastening the blade to the handle.

9. The spatula of claim 8, wherein the at least one mechanical fastener comprises a rivet or a threaded fastener.

10. The spatula of claim 1, wherein the handle is overmolded onto the blade.

11. The spatula of claim 1, wherein the handle extends along a first longitudinal axis, and wherein the blade extends along a second longitudinal axis angularly offset from the first longitudinal axis.

12. A spatula comprising:
a polymer handle; and
a metal blade extending along a longitudinal axis and having a radius of curvature in a direction radially outward from the longitudinal axis such that an upper surface of the metal blade is concave, the metal blade comprising:
a first end coupled to the polymer handle;
a second end opposite the first end;
a lower surface facing a downward direction and configured to engage a cooking surface; and
the upper surface opposite the lower surface and facing an upward direction opposite the downward direction;
wherein a first force required to deflect the second end of the metal blade in the upward direction is less than a second force required to deflect the second end of the metal blade in the downward direction.

13. The spatula of claim 12, wherein the radius of curvature of the metal blade at the first end is approximately 2.25 inches.

14. The spatula of claim 12, wherein the second force is at least ten times greater than the first force.

15. The spatula of claim 12, wherein the metal blade has a thickness in a range of 0.008 inches to 0.020 inches.

16. The spatula of claim 12, wherein a thickness of the metal blade is between 0.010 inches and 0.012 inches.

17. A spatula comprising:
a handle; and
a blade comprising:
a first end coupled to the handle, the first end having a first value of a radius of concavity; and
a second end opposite the first end, the second end having a second value of the radius of concavity different than the first value;
wherein the first value of the radius of concavity and the second value of the radius of concavity of the blade result in limiting the second end of the blade from bending in a downward direction when a first downward force is applied.

18. The spatula of claim 17, wherein the radius of concavity of the blade increases from the first end of the blade to the second end of the blade.

19. The spatula of claim 17, wherein the second end of the blade is prevented from bending in the downward direction until a second downward force is applied.

20. The spatula of claim 19, wherein the second downward force is larger than the first downward force.
